(19) United States
(12) Patent Application Publication
(10) Pub. No.: US 2026/0051123 A1
(43) Pub. Date: Feb. 19, 2026

(54) VERIFICATION OF SITE DEPLOYMENT

(71) Applicant: Telefonaktiebolaget LM Ericsson (publ), Stockholm (SE)

(72) Inventors: Fitsum Gaim GEBRE, Järfälla (SE); Jiangning GAO, Solna (SE); Rerngvit YANGGRATOKE, Järfälla (SE); Vincent HUANG, Sollentuna (SE)

(21) Appl. No.: 19/101,561

(22) PCT Filed: Aug. 8, 2022
(86) PCT No.: PCT/EP2022/072277

§ 371 Date: Feb. 5, 2025

(51) Int. Cl. G06T 17/20; G06N 5/02; G06N 5/04

(52) U.S. Cl. CPC G06T 17/20; G06N 5/02; G06N 5/04

(57) ABSTRACT

A method performed by a computing device for verification of a site deployment is provided. The method includes receiving a query that a property related to an object from a 3-D representation from a scan of the site deployment satisfies a specified property related to the object from a drawing of the design of the site. The method further includes initiating extraction of a first value from a first knowledge graph and a second value from a second knowledge graph. The method further includes determining whether the property related to the object from the 3-D representation satisfies the specified property related to the object from the drawing based on a comparison of the first and second values; and outputting a result.

### TECHNICAL FIELD

The present disclosure relates generally to a method performed by a computing device for verification of a site deployment, and related methods and apparatuses.

### BACKGROUND

Telecommunication network rollouts involve a site engineering process, which may include creating a design of a site in the form of a drawing (e.g., an engineering drawing) and implementing the design in an actual site deployment.

After the implementation of the design, pictures/videos of the site deployment may be obtained from various angles and elevations including, for example, with drone technologies. The captured data can be used to build a point cloud as a representation of the actual site deployment. FIG. 1 is an example drawing of a site design including a radio tower, antennas, etc. FIG. 2 is an example point cloud scan representation of the actual site deployment for the design illustrated in the drawing of FIG. 1.

### SUMMARY

There currently exist certain challenges. Automatic verification of measurements between a drawing of a site design and an actual deployment performed based on the drawing may be lacking. Automatic verification, however, may be important for at least the following reasons: (1) appropriate/proper performance of the deployed site; and/or (2) to satisfy an acceptance process (e.g., a contractual acceptance process before payment for performing the site deployment can be made).

Certain aspects of the disclosure and their embodiments may provide solutions to these or other challenges.

In some embodiments, a method performed by a computing device for verification of a site deployment is provided. The method includes receiving a query for verification that a property related to an object from a three-dimensional (3-D) representation from a scan of the site deployment satisfies a specified property related to the object from a drawing of the design of the site. The method further includes initiating extracting a first value for the specified property related to the object from a first knowledge graph based on the drawing and a second value for the property related to the object from a second knowledge graph based on the 3-D representation from the scan. The method further includes determining whether the property related to the object from the 3-D representation satisfies the specified property related to the object from the drawing based on a comparison of the first and second values. The method further includes outputting a result of the determining that indicates whether the property related to the object from the 3-D representation satisfies the specified property related to the object from the drawing.

In some embodiments, a computing device configured for verification of a site deployment is provided. The computing device includes processing circuitry; and memory coupled with the processing circuitry. The memory includes instructions that when executed by the processing circuitry causes the computing device to perform operations. The operations include to receive a query for verification that a property related to an object from a 3-D representation from a scan of the site deployment satisfies a specified property related to the object from a drawing of the design of the site. The operations further include to initiate extraction of a first value for the specified property related to the object from a first knowledge graph based on the drawing and a second value for the property related to the object from a second knowledge graph based on the 3-D representation from the scan. The operations further include to determine whether the property related to the object from the 3-D representation satisfies the specified property related to the object from the drawing based on a comparison of the first and second values. The operations further include to output a result of the determination that indicates whether the property related to the object from the 3-D representation satisfies the specified property related to the object from the drawing.

In some embodiments, a computing device configured for verification of a site deployment is provided, the computing device adapted to perform operations. The operations include to receive a query for verification that a property related to an object from a 3-D representation from a scan of the site deployment satisfies a specified property related to the object from a drawing of the design of the site. The operations further include to initiate extraction of a first value for the specified property related to the object from a first knowledge graph based on the drawing and a second value for the property related to the object from a second knowledge graph based on the 3-D representation from the scan. The operations further include to determine whether the property related to the object from the 3-D representation satisfies the specified property related to the object from the drawing based on a comparison of the first and second values. The operations further include to output a result of the determination that indicates whether the property related to the object from the 3-D representation satisfies the specified property related to the object from the drawing.

In some embodiments, a computer program is provided that includes program code to be executed by a processing circuitry of a computing device configured for verification of a site deployment. Execution of the program code causes the computing device to perform operations. The operations include to receive a query for verification that a property related to an object from a 3-D representation from a scan of the site deployment satisfies a specified property related to the object from a drawing of the design of the site. The operations further include to initiate extraction of a first value for the specified property related to the object from a first knowledge graph based on the drawing and a second value for the property related to the object from a second knowledge graph based on the 3-D representation from the scan. The operations further include to determine whether the property related to the object from the 3-D representation satisfies the specified property related to the object from the drawing based on a comparison of the first and second values. The operations further include to output a result of the determination that indicates whether the property related to the object from the 3-D representation satisfies the specified property related to the object from the drawing.

In some embodiments, a computer program product including a non-transitory storage medium including program code to be executed by processing circuitry of a computing device is provided. Execution of the program code causes the computing device to perform operations. The operations include to receive a query for verification that a property related to an object from a 3-D representation from a scan of the site deployment satisfies a specified property related to the object from a drawing of the design of the site. The operations further include to initiate extraction of a first value for the specified property related to the object from a first knowledge graph based on the drawing and a second value for the property related to the object from a second knowledge graph based on the 3-D representation from the scan. The operations further include to determine whether the property related to the object from the 3-D representation satisfies the specified property related to the object from the drawing based on a comparison of the first and second values. The operations further include to output a result of the determination that indicates whether the property related to the object from the 3-D representation satisfies the specified property related to the object from the drawing.

### BRIEF DESCRIPTION OF DRAWINGS

The accompanying drawings, which are included to provide a further understanding of the disclosure and are incorporated in and constitute a part of this application, illustrate certain non-limiting embodiments of inventive concepts. In the drawings:

FIG. 1 is an example drawing of a site design;

FIG. 2 is an example 3-D representation from a scan of a site deployed based on the drawing of FIG. 1;

FIG. 3 is a block diagram illustrating components and operations of an example embodiment in accordance with the present disclosure;

FIG. 4 is a flow chart illustrating a method performed by a computing device in accordance with some embodiments of the present disclosure;

FIG. 5 is a schematic diagram illustrating a first knowledge graph and a second knowledge graph in accordance with some embodiments of the present disclosure;

FIG. 6 is schematic diagram illustrating a first knowledge graph generated based on the drawing of FIG. 1 in accordance with some embodiments of the present disclosure;

FIG. 7 is schematic diagram illustrating a second knowledge graph generated based on the 3-D representation of FIG. 2 in accordance with some embodiments of the present disclosure;

FIGS. 8 and 9 are flowcharts illustrating operations of a computing device in accordance with some embodiments of the present disclosure;

FIG. 10 is a block diagram of a computing device in accordance with some embodiments of the present disclosure;

FIG. 11 illustrates three specific examples of a network device (ND) that may be used to implement particular embodiments of the present disclosure; and

FIG. 12 illustrates a further implementation example for particular embodiments of the present disclosure.

### DETAILED DESCRIPTION

Inventive concepts will now be described more fully hereinafter with reference to the accompanying drawings, in which examples of embodiments of inventive concepts are shown. Inventive concepts may, however, be embodied in many different forms and should not be construed as limited to the embodiments set forth herein. Rather, these embodiments are provided so that this disclosure will be thorough and complete, and will fully convey the scope of present inventive concepts to those skilled in the art. It should also be noted that these embodiments are not mutually exclusive. Components from one embodiment may be tacitly assumed to be present/used in another embodiment.

The following description presents various embodiments of the disclosed subject matter. These embodiments are presented as teaching examples and are not to be construed as limiting the scope of the disclosed subject matter. For example, certain details of the described embodiments may be modified, omitted, or expanded upon without departing from the scope of the described subject matter.

As previously referenced, automatic verification (e.g., as opposed to manual verification performed by a person) of measurements between a drawing of a site design and an actual deployment performed based on the drawing may be lacking. For ease of discussion, example embodiments herein are explained in the non-limiting context of a telecommunications site design and deployment. The present disclosure, however, is not so limited and the method is applicable to other site designs and deployments that include objects and relationships between objects (e.g., an industrial site, a wind turbine site, an oil rigging site, etc.).

The lack of automatic verification may be important to entities performing site design/deployment and to customers of such entities. For example, in the context of a telecommunication site, at least the following reasons may be important: (1) For a telecommunication network to perform appropriately/properly, it is important that the implementation of the actual site deployment follows the design indicated in the drawing as closely as possible. For example, the deployed network may cause coverage holes or communication issues if antenna azimuths are not set according to a specified property (or properties) from the drawing; and/or (2) matching of a design from the drawing and the actual deployment of the design may be part of an acceptance process (e.g., an acceptance process required by a contract or the customer) before a payment can be made. As a consequence, verification may identify deployment and installation mistakes or errors, which also may have an influence on safety of the site, energy efficiency, etc.

Moreover, the lack of automatic verification may not be trivial, e.g., when there are multiple properties that need to be verified between the drawing and the actual site deployment based on the drawing. For example, the properties may include, without limitation, an installed antenna height of a tower, an antenna azimuth, a tower height, distances between two legs of the tower, etc.

Some approaches for verification use manual verification by a person. For example, a person may climb up a tower(s), and manually perform several measurements in order to verify that the installation of the site was deployed according to the design indicated in a drawing. Climbing a tower(s) and manually performing verification, however, may be dangerous, time consuming, may have high operational expenses, and/or and may not be scalable for a number of sites. Additionally, in manual verification, quality of the results may depend on the individuals performing the task.

Another approach for verification may compare or map a building information model (BIM) with a point cloud scan. Such an approach may be applicable to BIM and may not be applicable to many other sites including, without limitation, telecommunication sites. Comparison of a BIM with a point cloud scan may not, e.g., provide rich semantic information for describing semantics of radio products and may not be interpretable by engineers. Additionally, a comparison of BIM and a point cloud scan may be done in a specialized software that may only compare geometric properties.

Certain aspects of the disclosure and their embodiments may provide solutions to these or other challenges. In some embodiments, a computer-implemented method is performed by a computing device for verification of a site deployment. The method includes receiving a query that a property related to an object from a 3-D representation from a scan of the site deployment satisfies a specified property related to the object from a drawing of the design of the site. The method further includes initiating extraction of a first value for the specified property related to the object from a first knowledge graph based on the drawing and a second value for the property related to the object from a second knowledge graph based on the 3-D representation from the scan. The method further includes determining whether the property related to the object from the 3-D representation satisfies the specified property related to the object from the drawing based on a comparison of the first and second values. The method further includes outputting a result of the determining that indicates whether the property related to the object from the 3-D representation satisfies the specified property related to the object from the drawing.

In some embodiments, the method includes generating and/or using knowledge graphs from a drawing and a 3-D representation from a scan (e.g., a point cloud scan), respectively, querying information from the knowledge graphs (e.g., according to check list for verifying compliance with a contract for the site deployment), and comparing answers from the knowledge graphs to determine whether the answers satisfy a specified property from the drawing by being within an acceptable threshold value.

A query may be in natural language, as discussed further herein. For example, in some embodiments, the method supports semantic information such as “the azimuth of the antenna” from the drawing, and operations of the present disclosure support t a natural language process (NLP) to process the query.

Technical advantages provided by certain embodiments of the present disclosure may include that, e.g., in contrast to approaches using manual verification by a person, inclusion in the computer-implemented method of the query and knowledge graphs to obtain the result may provide automatic verification that a site deployment satisfies the drawing. As a consequence, the method may be more accurate, less time-consuming, less dangerous, less expensive, have lower operational expenses, and/or may be scalable for multiple sites. Additional potential technical advantages may include that, e.g., in contrast to approaches using a BIM, the method may be applicable to non-BIM site deployments, may provide semantic information (e.g., from text on the drawing or in another knowledge graph regarding equipment in the site), may be interpretable by engineers, and may compare more than geometric properties (e.g., a comparison of the method may include the semantic information, etc.).

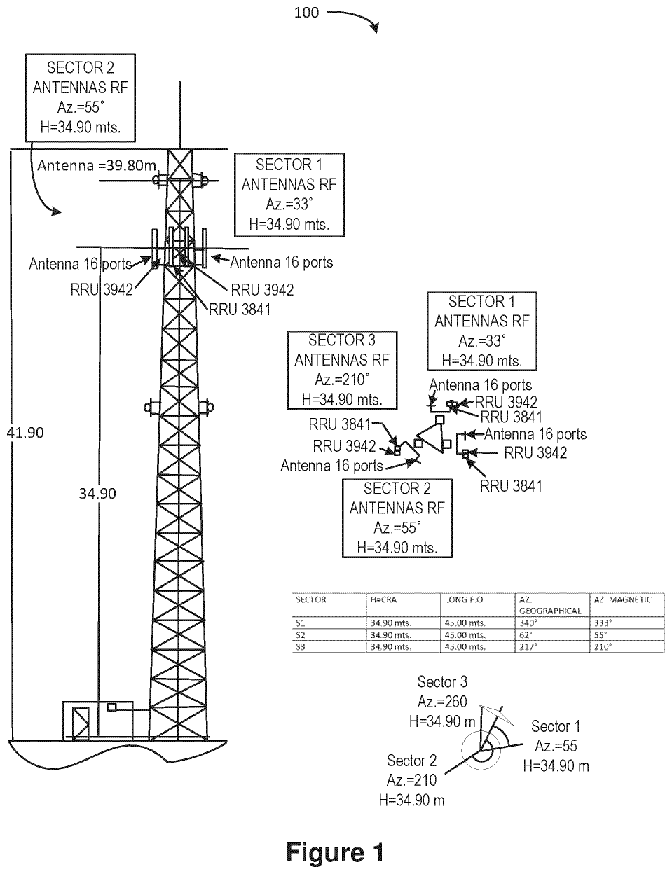

FIG. 1 is an example drawing 100 of a site design including a radio tower, antennas on the radio tower, a number of ports per antenna (e.g., 16 ports), the geographical azimuth of each antenna (e.g., 33°, 55°, 210°, respectively), the height of each antenna (e.g., 34.9 meters), a number of sectors (e.g., 3 sectors), a height of the tower from the ground (e.g., 41.90 meters), remote radio unit (RRU) locations, RRU model numbers (e.g., RRU 3841 and RRU 3942), etc. While the example embodiment of FIG. 1 is described with reference to a drawing of including a radio tower, the disclosure is not so limited, and includes drawings of other objects in other sites, such as a wind turbine tower, an oil rig, etc., having parameters such as height, blade length, platform height above water, width, etc.

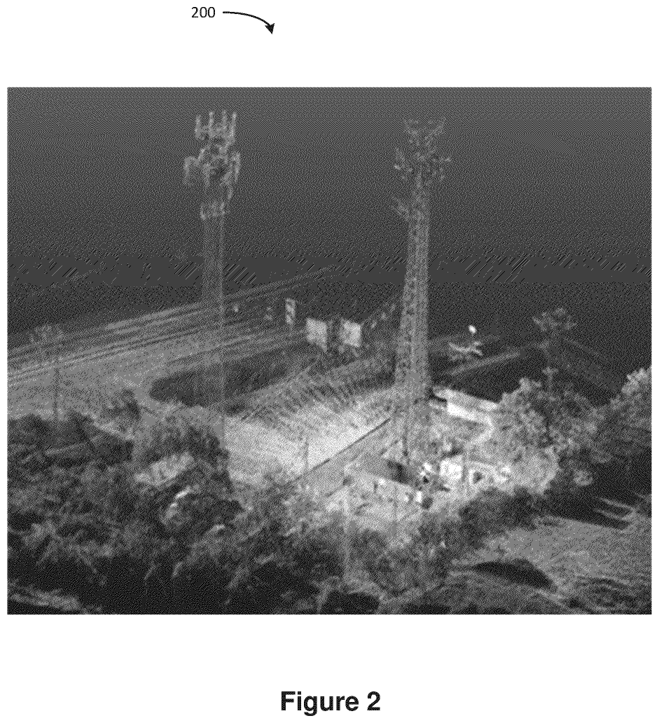

FIG. 2 is an example 3-D representation from a scan in the form of a point cloud scan of the actual site deployment based on the drawing illustrated in FIG. 1.

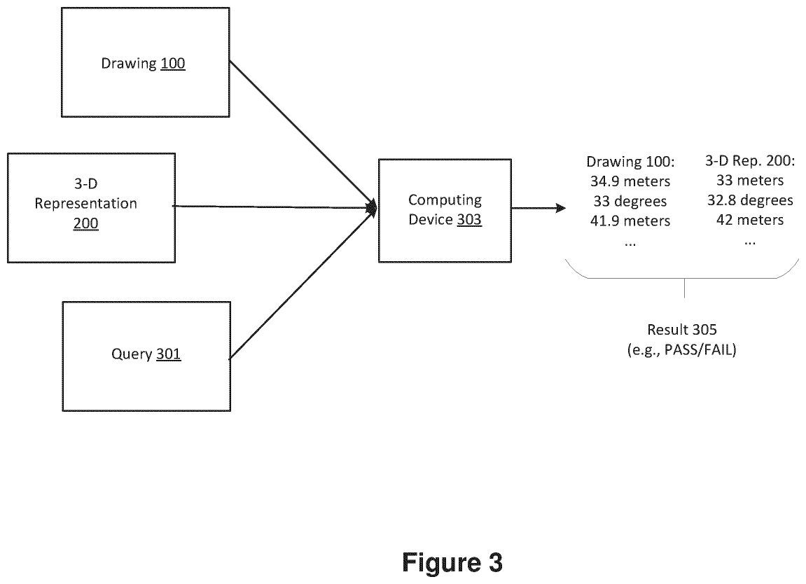

FIG. 3 is a block diagram illustrating components and operations of an example embodiment in accordance with the present disclosure. In the example embodiment, drawing 100, 3-D representation 200, and a query 301 are provided as inputs to computing device 303. Query 301 includes a question(s) in natural language. For example, query 301 of this example embodiment includes at least the following questions regarding objects and properties:
Are the antennas installed at the correct height?
Is the azimuth of antenna in Sector 1 set correctly?
Is the tower height correct?

For each question in query 301, computing device 303 extracts a first value for the specified property related to the object(s) from a first knowledge graph based on drawing 100, and a second value for the property related to the object(s) from a second knowledge graph based on the 3-D representation 200. Computing device 303 determines whether the property related to the object from the 3-D representation 200 satisfies the specified property related to the object from the drawing 100 based on a comparison of the first and second values. Computing device 303 outputs a result 305 of the determining that indicates whether the property related to the object from the 3-D representation 200 satisfies the specified property related to the object from the drawing 100. In this example embodiment, the first and second values for the specified property from drawing 100 and the property from 3-D representation for each of the above questions, respectively, are as follows:

| | |
|---|---|
| Drawing 100: | 3-D Representation: |

| | | | |
|---|---|---|---|
| 34.9 | meters | 33 | meters |
| 33 | degrees | 32.8 | degrees |
| 41.9 | meters | 42 | meters |

Result 305 may indicate a PASS or FAIL for each query (e.g., a PASS or FAIL based on the second value for the object being within a threshold value of the first value (within ±1.0).

As used herein, the term “computing device” refers to equipment capable, configured, arranged, and/or operable to verify the site deployment in accordance with embodiments of the present disclosure. As discussed further herein, examples of computing devices include, without limitation, a centralized device, a distributed device having distributed logical and/or physical entities, a standalone device in a location near the site, a border device, an edge device, a cloud-based device, etc. For example, when the computing device includes a logical entity, part of the computing device may be cloud-based. For example, performing an operation of the method may be seen at the same logical device, but with different physical devices, etc.

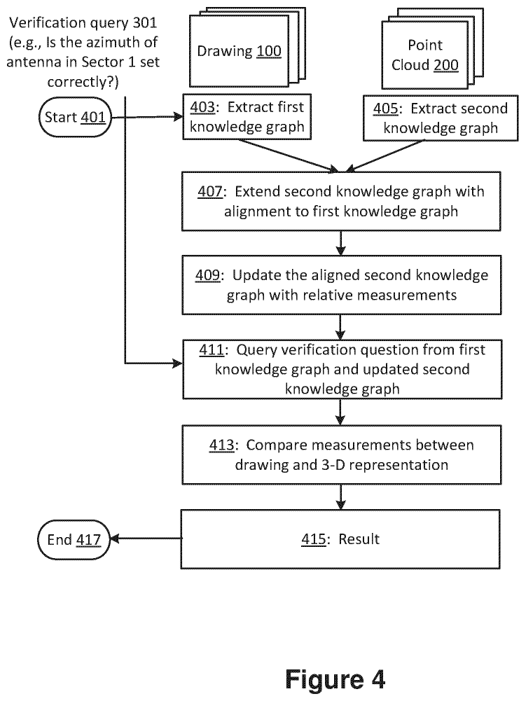

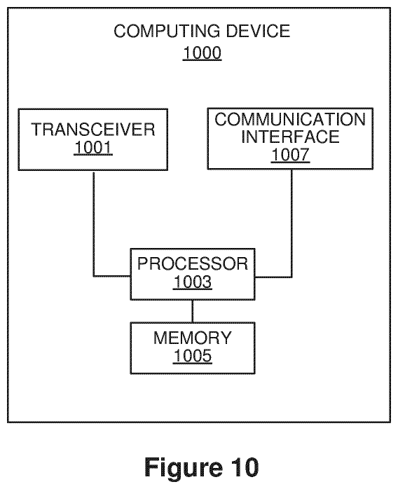

FIG. 4 is a flow chart illustrating a method performed by a computing device (e.g., computing device 303 implemented using the structure of FIG. 10) in accordance with some embodiments. For ease of discussion, an overview of the operations of the method of FIG. 4 is discussed below, followed by a more detailed discussion of the operations of FIG. 4.

The method starts 401 with computing device 303 receiving query 301 comprising the question: Is the azimuth of antenna in Sector 1 set correctly? In operation 403, computing device 303 extracts a first knowledge graph from drawing 100. In operation 405, computing device 303 extracts a second knowledge graph from 3-D representation 200 (e.g., from a point cloud scan). In operation 407, computing device 303 extends the second knowledge graph with alignment to the first knowledge graph. The aligned second knowledge graph is updated, in operation 409, with relative measurements. In operation 411, the query 301 is queried from the first knowledge graph and the updated second knowledge graph. Computing device 303 compares 413 measurements between the first knowledge graph based on the drawing 100 and the second knowledge graph 200 based on the 3-D representation. In operation 415, computing device 303 outputs the result; and the method ends 417.

In this example embodiment, operation 403 generates the first knowledge graph based on the provided input drawing(s) 100. The input drawing(s) 100 includes a depiction of telecommunication site equipment and features of the site (e.g., the ground, etc.) illustrated with reference to FIG. 1 herein. The term “object” is used in a non-limiting manner and refers to any equipment and features (e.g., geographic or other features) of a site. Input drawing 100 includes, without limitation, relationships between objects (e.g., between the tower and the antenna, the tower and the ground, etc.), and text-labels that describe properties and relationships of objects. In some embodiments, drawing 100 follows an industry design convention, such as a telecommunications site design convention for drawings. In operation 403, drawing 100 is parsed into abstract semantic elements (in other words, into objects and their connections/relationships). The parsing may be performed using Scene Graph Generation (SGG).

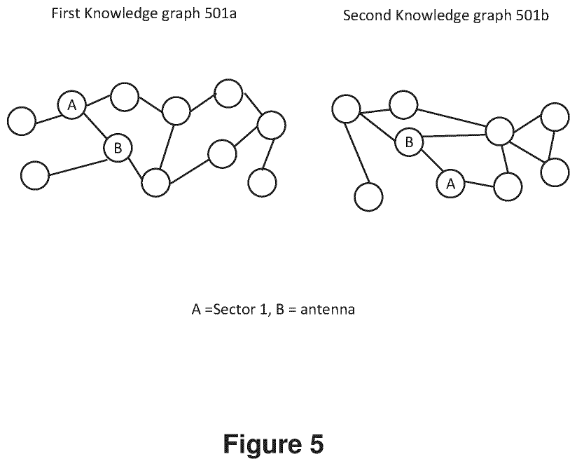

Operation 403 extracts a symbolic representation from drawing(s) 100 or a portion of a drawing 100. The symbolic representation may be in the form of nodes and edges of a graph, e.g., as illustrated in the first knowledge graph 501a of FIG. 5 from a portion of drawing 100 in FIG. 1. In first knowledge graph 501a, each node corresponds to a localized and categorized object or a literal value for the object, and each edge in first knowledge graph 501a encodes a pairwise interaction (e.g., a predicate) between the objects which can be, e.g., a text description of standardized symbols in drawing 100. As illustrated in the example embodiment of first knowledge graph 501a in FIG. 5, node A corresponds to Sector 1 from drawing 100, node B corresponds to the antenna in Sector 1 from drawing 100, and the edge between nodes A and B encode a pairwise interaction between Sector 1 and the antenna specifying that a property of the azimuth of the antenna in Sector 1 in drawing 100 is 33 degrees.

It is noted that site drawings may not include detailed information about objects in the drawings. For example, telecommunication site drawing 100 depicts an RRU and includes text identifying the RRU as “RRU 3942”. Drawing 100, however, does not include technical data for the RRU 3942 product, e.g., its exact dimensions. Such additional information, however, may be available in an external knowledge source or is part of an expert's knowledge. Thus, in some embodiments, the first knowledge graph extracted from drawing 100 is further aligned with a pre-existing, deployment-agnostic knowledge graph of object information or other general information, such as telecommunications product information. The additional information may provide context and augment information missing in the drawing(s) that may be important to the subsequent operations of the method.

Operation 403 may include various approaches for generating the first knowledge graph including, without limitation, using object detection and optical character recognition techniques from the field of computer vision with emphasis on recognizing detailed relationships between objects and the interaction of objects within their environment. Examples include visual relationship detection discussed in Guangming Zhu, “Scene Graph Generation: A Comprehensive Survey,” in arXiv, 2022 and J. Zhang, “Large-scale visual relationship understanding,” in Proceedings of the AAAI Conference on Artificial Intelligence, 2019, and/or human-object interaction (HOI) discussed in G. Gkioxari, “Detecting and recognizing human-object interactions,” in Proceedings of the IEEE Conference on Computer Vision and Pattern Recognition, 2018 and S. Qi, “Learning human-object interactions by graph parsing neural networks,” in Proceedings of the European Conference on Computer Vision (ECCV), 2018.

Operation 403 may include (1) object detection, (2) object property detection from auxiliary lines, and (3) text description recognition.

Object detection, such as telecommunication equipment detection, finds objects of certain classes that are depicted in drawing 100 (e.g., RRU, antenna, tower, etc.). A machine learning (ML) model can be trained to perform the object detection (e.g., object segmentation via bounding boxes) regardless of the manufacturer of the equipment.

Object property detection from auxiliary lines may include handling digitization of supporting information found in the drawings in the form of, e.g., lines and arrows that are disjoint from the main body of the object. The properties may indicate the physical dimensions of an object such as the height, width, and distance between the object and other objects. A computer graphics algorithm or a ML model can be used to detect such lines that are adjacent to the object but are not part of the main body of the object. Based on the location and shape of the auxiliary line, the computer graphics algorithm or ML model can be used to make a preliminary prediction of the type of the property, e.g., the height of the object, a distance between the object and another object, etc. The lines also may contain text information such as labels, numbers, units of measurement, etc. that are included in the objects detected as properties the objects. For example, as part of a bounding box for the lines. Operation 403 includes matching of an object(s) and a specified property or properties from the drawings. The proximity between an auxiliary line and an object may be a feature used to determine the association.

Text description recognition provides semantic information for an object(s) detected in the object detection and object property detection. For example, an object may be detected as an RRU in the object detection, but only by reading an auxiliary label” is the exact model of the RRU extracted from the drawing, for example, text stating “RRU 3942” as illustrated in drawing 100 of FIG. 1.

Text description recognition also may use text around an auxiliary line to enhance the detected type of property depicted by a line. For example, object property detection may have predicted a certain line as indicating the width of an object text description recognition may recognize text indicating that the property refers to height, such as “H:41.80M”, and an adjustment can be done accordingly.

The first knowledge graph is provided as an output of operation 403 and is used as an input in subsequent operations of the method, such as illustrated in the example embodiment of FIG. 4.

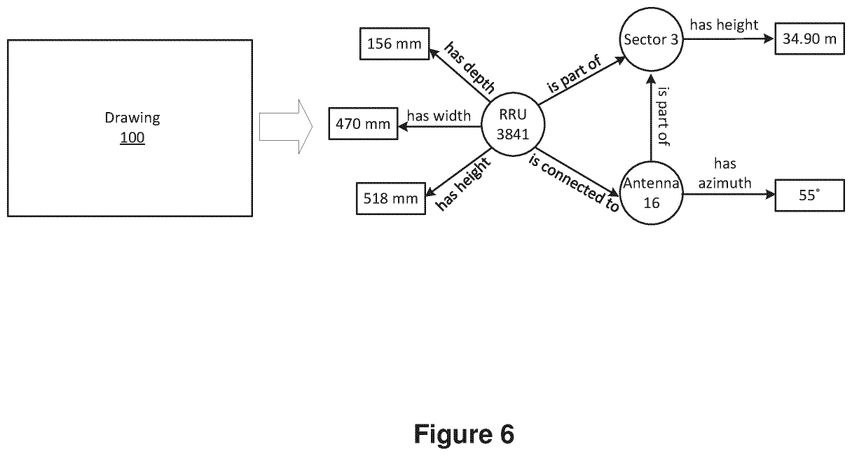

FIG. 6 is schematic diagram illustrating an example embodiment of a first knowledge graph generated based on a portion of drawing 100 of FIG. 1 in accordance with some embodiments of the present disclosure. The first knowledge base illustrated in FIG. 6 include nodes for RRU 3841, Sector 3, and Antenna 16, respectively. An edge between the node for RRU 3841 and the node for Sector 3 indicates the RRU 3841 is a part of Sector 3. An edge between the node for RRU 3841 and the node for Antenna 16 indicates that RRU 3841 is connected to Antenna 16. An edge between the node for Sector 3 and the node for Antenna 16 indicates that Antenna 16 is part of Sector 3. Specific properties for the node representing RRU 3841 are identified as has depth of 156 mm, has width 470 mm, has height 518 mm. A specified property for the node representing Sector 3 is identified as has height 34.90 meters. A specific property for the node representing Antenna 16 is identified as has azimuth 55°.

Operation 405 extracts a symbolic representation from 3-D representation(s) from a scan 200 or a portion of a 3-D representation from a scan 200. The symbolic representation may be in the form of nodes and edges of a graph, e.g., as illustrated in the second knowledge graph 501b of FIG. 5 from a portion of 3-D representation 200 in FIG. 2. In second knowledge graph 501b, each node corresponds to a localized and categorized object or a literal value for the object, and each edge in second knowledge graph 501b encodes a pairwise interaction (e.g., a predicate) between the objects. As illustrated in the example embodiment of second knowledge graph 501b in FIG. 5, node A corresponds to Sector 1 from 3-D representation 200, node B corresponds to the antenna in Sector 1 from 3-D representation 100, and the edge between nodes A and B encode a pairwise interaction between Sector 1 and the antenna identifying that a property of the azimuth of the antenna in Sector 1 in drawing 100 is 32.8 degrees.

A computer vision algorithm and/or a ML model may be used to find measurements including, without limitation, 3-D object identification and localization, a relationship(s) among neighboring objects, a dimension (e.g., length, width, and height) and rotation (e.g., pitch, roll and yaw) of an object(s). The 3-D representation may be a point cloud scan. An input point cloud scan(s) may be reconstructed from photogrammetry together with corresponding two-dimensional (2D) input images, or the point cloud scan may be directly generated from scanner such as a Lidar scanner.

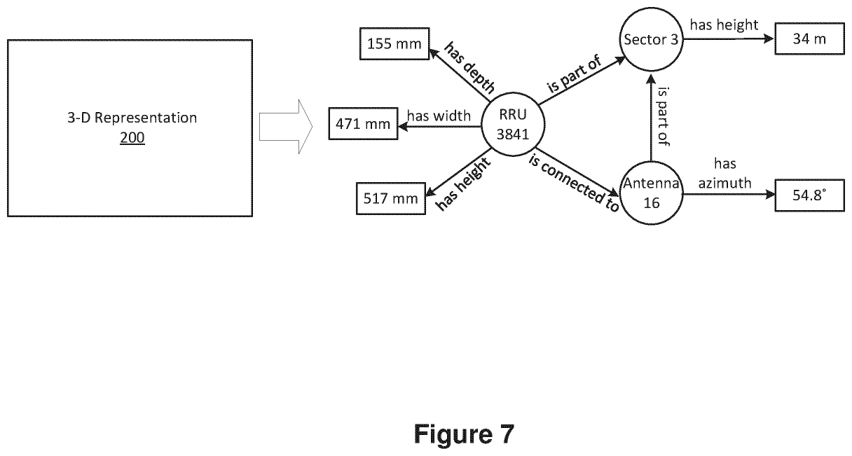

FIG. 7 is schematic diagram illustrating an example embodiment of a second knowledge graph generated based on a portion of 3-D representation 200 of FIG. 2 in accordance with some embodiments of the present disclosure. The second knowledge base illustrated in FIG. 7 include nodes for RRU 3841, Sector 3, and Antenna 16, respectively. An edge between the node for RRU 3841 and the node for Sector 3 indicates the RRU 3841 is a part of Sector 3. An edge between the node for RRU 3841 and the node for Antenna 16 indicates that RRU 3841 is connected to Antenna 16. An edge between the node for Sector 3 and the node for Antenna 16 indicates that Antenna 16 is part of Sector 3. Specific properties for the node representing RRU 3841 are identified as has depth of 155 mm, has width 471 mm, has height 517 mm. A specified property for the node representing Sector 3 is identified as has height 34 meters. A specific property for the node representing Antenna 16 is identified as has azimuth 54.8°.

Operation 405 may include object identification, centroid detection, and connections. For example, a trained object detector may help identify objects, such as the RRU, Sector, and Antenna as illustrated in the second knowledge graph of FIG. 7. After identification, an object name and model number may be obtained; and the centroid of each object may be found within each detection which can help find the connections among objects. For example, as illustrated in the second knowledge graph in FIG. 7, RRU 3841 is connected to Antenna 16.

Operation 405 may further include object dimension and rotation (such as for a piece of telecommunications equipment deployed in a telecommunication site), and other object detection and height (such as for a Sector in a deployed telecommunication site). For example, for an object(s), a point cloud densification may be executed to measure/help ensure accurate measurement of the length, width, and height as well as the object's location information to indicate if the object was installed in the right place. For example, height from the ground and the absolute height may be measured. Additionally, rotation information may be measure including, without limitation azimuth or tilt (e.g., the azimuth 54.8° illustrated in FIG. 7) which may help verify/check the corresponding property in the drawing 100 and detect the Sector. Further, objects may be grouped. For example, in FIG. 7, both RRU 3841 and Antenna 16 are grouped as part of Sector 3.

Operation 407 includes extending the second knowledge graph with alignment to the first knowledge graph. Since the first knowledge graph and the second knowledge graph are extracted from different data sources, i.e., a drawing and a 3-D representation, they can contain different representations of the same real-world objects (e.g., an antenna in Sector 1, an RRU, a first cell site, etc.). Operation 407 extends the second knowledge graph to align with the first knowledge graph, so that the same real-world object can be identified (and subsequently compared) between the two knowledge graphs. In other words, an object represented by a node is updated with corresponding predicates in the knowledge graph with a link to an object represented by a node in the second knowledge graph. Operation 407 may be performed in an entity alignment task, e.g., such as Mark Heimann, “REGAL: Representation Learning-based Graph Alignment,” [Online]. Available: https://arxiv.org/abs/1802.06257; Renbo Zhu, “RAGA: Relation-aware Graph Attention Networks for Global Entity Alignment,” [Online]. Available: https://arxiv.org/abs/2103.00791v1; and K. Z. e. al., “A comprehensive survey of entity alignment for knowledge graphs,” [Online]. Available: https://www.sciencedirect.com/science/article/pii/S2666651021000036.

Alternatively, operation 407 can include aligning each node n₁ in the first knowledge graph to another node n₂ in the second knowledge graph with a highest node matching score. In an example embodiment, the node matching score is computed as follows:
The value for each property p of node n₁ is represented by val (p, n₁), and the value for each property p of node n₂ is represented by val (p, n₂).
P represents a shared set of properties between n₁ and n₂. Examples of such properties include, without limitation (1) object types (e.g., antenna, RRU, etc.) and (2) measurement (e.g., telecommunication measurements such as, e.g., tower height, antenna azimuth, etc.).
The matching score between n₁ and n₂ may come from a weight average from all properties in P. A weight wₚ represents normalization adjustments to make different properties comparable (e.g., on a similar range). The weight wₚ may be be 1 or a range of values of for a property p

$$matching\_score ( {n}_{1} , {n}_{2} ) = {\sum }_{p}^{P} {w}_{p} \vert val ( p , {n}_{1} ) - val ( p , {n}_{2} ) \vert$$

Operation 409 includes updating the aligned second knowledge graph with relative measurements. In operations 403-407, individual measurements were considered such as a specific measurement from a particular object (e.g., the height of a tower, an azimuth/width/height of an antenna, etc.). Such individual measurements, however, may not be sufficient for some queries that need measurements between two objects (e.g., a distance between two tower legs, an installed height of an antenna (e.g., a measurement between the ground and the antenna)). Thus, operation 409 augments the second knowledge graph with relative measurements between two objects. In an example embodiment, operation 409 includes:
For each pair of objects A and B in the second knowledge graph, compute a distance d_{A,B} (e.g., Euclidean distance, distance along axis x,y,z, etc.) from the second knowledge graph generated from operation 405. A centroid for A and B computed in operation 405 may be used as a representation.
Add a new relative distance node d_{A,B} into the second knowledge graph.
Add a “has relative distance” edge from A and B to this new node d_{A,B} into the second knowledge graph

Operation 411 includes making the query (e.g., query 301) from the first knowledge graph and the updated second knowledge graph. Operation 411 receives the query as input. The inputter query may be in natural language text. Operation 411 can extract the object(s) and property (or properties) using NLP, such as named entity recognition (NER) and intent classification. Once the objects and intents are identified, the information can be used to make two independent queries on the first knowledge graph and the updated second knowledge graph, respectively. Operation 411 results in two separate values extracted from the respective knowledge graphs which are passed to operation 413. Operation 411 may be performed based on applying processes for extracting information from natural text and applying queries to knowledge graphs.

In an example embodiment, for the input query “Verify installation height for Antenna 16 in Sector 3”, the “Antenna 16” and “Sector 3” are identified as objects, while “installation height” is a desired property. By querying the first and second knowledge graphs with this information, two values are obtained (e.g., 34.9 in the first knowledge graph and 34 in the second knowledge graph of FIGS. 6 and 7, respectively). These values can be passed for further analysis in operation 413.

Operation 413 includes comparing the measurements between the first knowledge graph and the second knowledge graph. Operation 413 determines whether the two measurements from the first knowledge graph and the second knowledge graph, respectively, yield a verification (e.g., a pass/fail verification). In one embodiment, to take that decision, a threshold is given (e.g., according to domain knowledge) based on the difference between the two values. For example, if the difference between the two values is within 0.05 degrees, the difference is considered acceptable. In another embodiment, if the first value is with a specified percentage of the second value, the difference is considered acceptable.

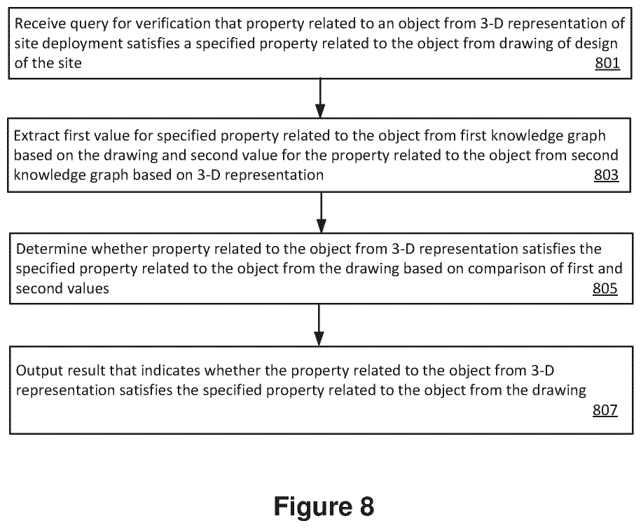

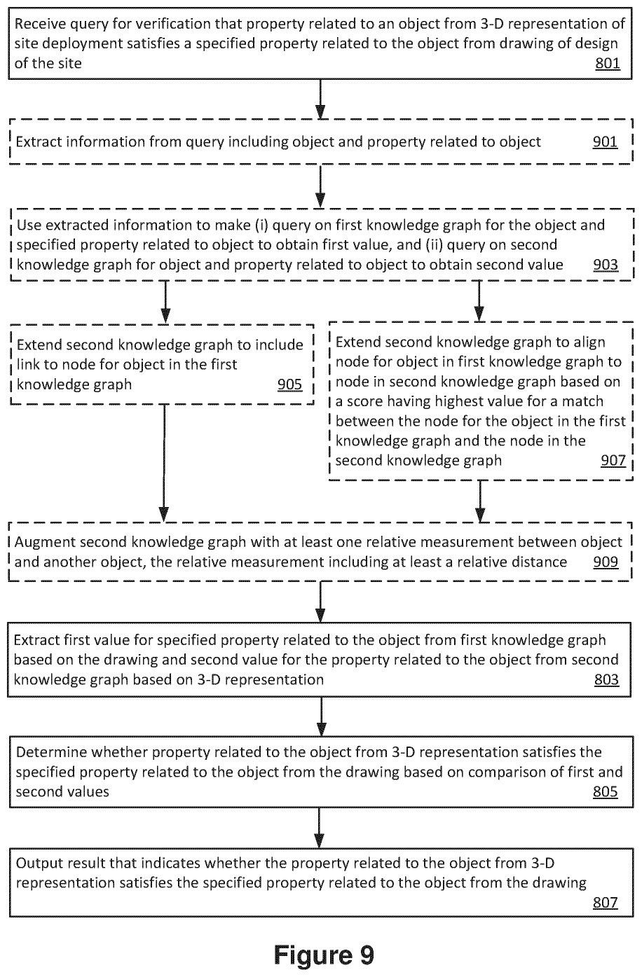

Operations of the computing device 303 (implemented using the structure of the block diagram of FIG. 10) will now be discussed with reference to the flow charts of FIGS. 8 and 9 according to some embodiments of the present disclosure. For example, modules may be stored in memory 1005 of FIG. 10, and these modules may provide instructions so that when the instructions of a module are executed by respective computing device processing circuitry 1003, processing circuitry 1003 performs respective operations of the flow charts.

Referring first to FIG. 8, a computer-implemented method performed by a computing device for verification of a site deployment is provided. The method includes receiving (801) a query for verification that a property related to an object from a 3-D representation from a scan of the site deployment satisfies a specified property related to the object from a drawing of the design of the site. The method further includes initiating extraction (803) of a first value for the specified property related to the object from a first knowledge graph based on the drawing and a second value for the property related to the object from a second knowledge graph based on the 3-D representation from the scan. For example, computing device 303, 1000 may perform actual extraction of the first value itself, or computing device 303, 1000 may initiate another device, component, or service (e.g., a cloud based service) to perform extraction of the first value on behalf of computing device 801. The method further includes determining (805) whether the property related to the object from the 3-D representation satisfies the specified property related to the object from the drawing based on a comparison of the first and second values. The method further includes outputting (807) a result of the determining that indicates whether the property related to the object from the 3-D representation satisfies the specified property related to the object from the drawing.

The drawing may include a depiction of a plurality of objects, a relationship between at least the object and another object, and a text label that describes at least the specified property of the object.

The 3-D representation from the scan may include at least one of a point cloud scan, a 3-D mesh, and a 3-D voxel including a representation of a plurality of objects in the site deployment, and a relationship between at least the object and another object.

The query may include a natural language query.

Referring to FIG. 9, the method may further include extracting (901) information from the query including the object and the property related to the object; and using (903) the extracted information to make a (i) query on the first knowledge graph for the object and the specified property related to the object to obtain the first value, and (ii) query on the second knowledge graph for the object and the property related to the object to obtain the second value.

In some embodiments, the extracting (901) includes generating the first knowledge graph based on the drawing of the design of the site; and generating the second knowledge graph based on the 3-D representation of the site deployment. The generating the first knowledge graph may include extracting, from the drawing, a symbolic representation in the form of a plurality of nodes and a plurality of edges of the first knowledge graph.

Respective nodes from the plurality of nodes may correspond to at least one of (i) a localization and categorization of the object from the drawing, or (ii) a measurement value for the object, and respective edges from the plurality of edges may encode a pairwise relationship between at least the object and another object from the drawing.

Extracting the symbolic representation may include one or more of (i) detecting the object from the drawing; (ii) detecting, from the drawing, the specified property related to the object, (iii) recognizing a text description, from the drawing, related to the object, and (iv) detecting a relationship or connection between the object and another object when available.

In some embodiment, generating the first knowledge graph further includes augmenting the first knowledge graph with information about the object obtained from an external third knowledge graph including information about at least the object or a knowledge graph of general information.

In some embodiments, generating the second knowledge graph includes extracting, from the 3-D representation, a symbolic representation in the form of a plurality of nodes and a plurality of edges of the second knowledge graph.

Respective nodes from the plurality of nodes may correspond to a plurality of objects and a measurement value for the object, and the respective edges from the plurality of edges may encode a pairwise relationship between at least the object and another object from the 3-D representation.

Extracting the symbolic representation may include one or more of (i) detecting the object from the 3-D representation; (ii) detecting, from the 3-D representation, the property related to the object; and (iii) extracting a relationship or a connection between the object and another object when available.

The method may further include extending (905) the second knowledge graph to include a link to a node for the object in the first knowledge graph.

In some embodiments, the method further includes extending (907) the second knowledge graph to align a node for the object in the first knowledge graph to a node in the second knowledge graph based on a score having a highest value for a match between the node for the object in the first knowledge graph and the node in the second knowledge graph.

The method may further include augmenting (909) the second knowledge graph with at least one relative measurement between the object and another object, the relative measurement comprising at least a relative distance.

In some embodiments, the drawing includes a drawing of a design of at least a portion of radio site and the 3-D representation from the scan includes at least the portion of the site deployed based on the drawing.

The operations from the flow chart of FIG. 9 may be optional with respect to some embodiments of computing devices and related methods. For example, operations of blocks 901-909 may be optional.

FIG. 10 shows a computing device 1000 in accordance with some embodiments. A computing device may be a centralized device, or may include one or more (or all) parts of a distributed computing device such as a centralized logical device and distributed physical devices. Additionally, one or more (or all) parts of the computing device may be cloud-based.

The computing device 1000 includes a processor 1003, a memory 1005, a communication interface 1007. The computing device 1000 may be composed of multiple physically or logically separate components, which may each have their own respective components. In certain scenarios in which the computing device 1000 comprises multiple separate logical and/or physical components, one or more of the separate components may be shared among several computing devices. For example, a controller may control multiple computing devices. In such a scenario, each unique computing device and controller pair, may in some instances be considered a single separate computing device. The computing device 1000 may also include multiple sets of the various illustrated components for different wireless technologies integrated into computing device 1000, for example Global System for Mobile Communications (GSM), Wideband Code Division Multiple Access (WCDMA), Long Term Evolution (LTE), New Radio (NR), wireless local area network (WLAN) standards, such as the Institute of Electrical and Electronics Engineers (IEEE) 802.11 standards (WiFi), Near Field Communication (NFC) Zigbee, Z-wave, long range wide area network (LoRaWAN), Radio Frequency Identification (RFID) or Bluetooth wireless technologies. These wireless technologies may be integrated into the same or different chip or set of chips and other components within computing device 1000.

The processor 1003 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other computing device 1000 components, such as the memory 1005, to provide computing device 1000 functionality.

In some embodiments, the processor 1003 includes a system on a chip (SOC). In some embodiments, the processor 1003 includes processing circuitry on separate chips (or sets of chips), boards, or units, such as digital units.

The memory 1005 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processor 1003. The memory 1005 may store any suitable instructions, data, or information, including a computer program, software, an application including one or more of logic, rules, code, tables, and/or other instructions capable of being executed by the processor 1003 and utilized by the computing device 1000. The memory 1005 may be used to store any calculations made by the processor 1003 and/or any data received via the communication interface 1007. In some embodiments, the processor 1003 and memory 1005 is integrated.

The communication interface 1007 is used in wired or wireless communication of signaling and/or data between a computing device, a communication network, and/or other devices. As illustrated, the communication interface 1007 comprises port(s)/terminal(s) to send and receive data, for example to and from a network over a wired connection. The communication interface 1007 may pass digital data to the processing circuitry QQ302. In other embodiments, the communication interface may comprise different components and/or different combinations of components.

The computing device 1000 may include one or more transceivers 1001 used to communicate, such as by communicating with one or more remote transceivers of another device capable of wireless communication (e.g., a distributed portion of the computing device 1000 or another device in a communication network). Each transceiver may include a transmitter and/or a receiver (not illustrated) appropriate to provide network communications (e.g., optical, electrical, frequency allocations, and so forth). Moreover, the transmitter and receiver may share circuit components, software or firmware, or alternatively be implemented separately.

According to some other embodiments, a computing device 1000 may be implemented without a transceiver 1001. In such embodiments, transmission to a wireless device may be initiated by the computing device 1000 so that transmission to the wireless device is provided through a device including a transceiver (e.g., through a base station). According to embodiments where the computing device 1000 includes a transceiver, initiating transmission may include transmitting through the transceiver.

The computing device 1000 also may include a power source (not illustrated). The power source may provide power to the various components of computing device 1000 in a form suitable for the respective components (e.g., at a voltage and current level needed for each respective component). The power source may further comprise, or be coupled to, power management circuitry to supply the components of the computing device 1000 with power for performing the functionality described herein. For example, the computing device 1000 may be connectable to an external power source (e.g., the power grid, an electricity outlet) via an input circuitry or interface such as an electrical cable, whereby the external power source supplies power to power circuitry of the power source. As a further example, the power source may comprise a source of power in the form of a battery or battery pack which is connected to, or integrated in, power circuitry. The battery may provide backup power should the external power source fail.

Embodiments of the computing device 1000 may include additional components beyond those shown in FIG. 10 for providing certain aspects of the computing device's functionality, including any of the functionality described herein and/or any functionality necessary to support the subject matter described herein. For example, the computing device 1000 may include user interface equipment to allow input of information into the computing device 1000 and to allow output of information from the computing device 1000. This may allow a user to perform diagnostic, maintenance, repair, and other administrative functions for the computing device 1000.

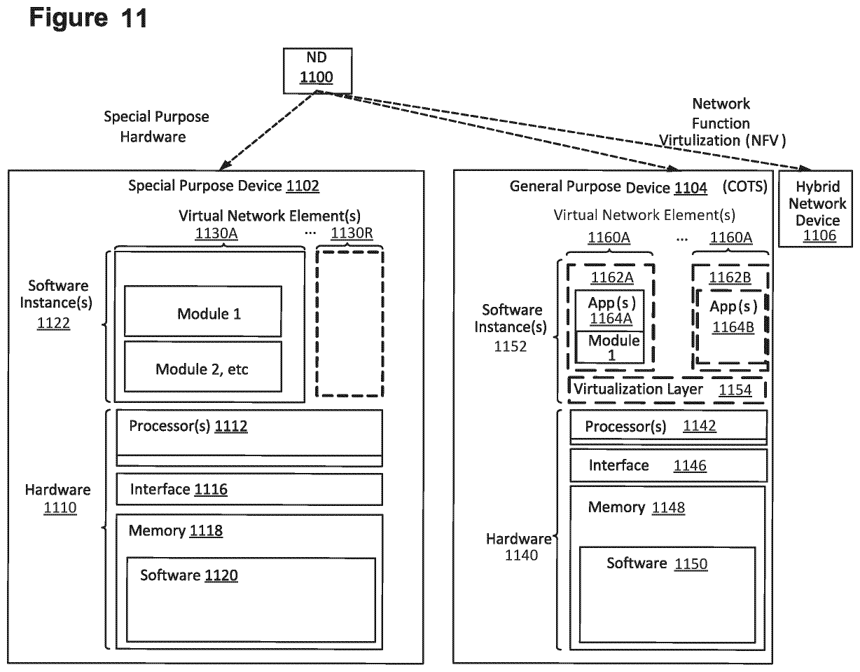

FIG. 11 illustrates two specific examples of how computing device 1000 (referred to as ND 1100 in FIG. 11) may be implemented in certain embodiments of the present disclosure including: 1) a special-purpose network device 1102 that uses custom processing circuits such as application-specific integrated-circuits (ASICs) and a proprietary operating system (OS); and 2) a general purpose network device 1104 that uses common off-the-shelf (COTS) processors and a standard OS which has been configured to provide one or more of the features or functions disclosed herein.

Special-purpose network device 1102 includes hardware 1110 comprising processor(s) 1112, and interface 1116, as well as memory 1118 having stored therein software 1120. In one embodiment, the software 1120 implements the modules described with regard to the previous figures. During operation, the software 1120 may be executed by the hardware 1110 to instantiate a set of one or more software instance(s) 1122. Each of the software instance(s) 1122, and that part of the hardware 1110 that executes that software instance (be it hardware dedicated to that software instance, hardware in which a portion of available physical resources (e.g., a processor core) is used, and/or time slices of hardware temporally shared by that software instance with others of the software instance(s) 1122), form a separate virtual network element 1130A-R. Thus, in the case where there are multiple virtual network elements 1130A-R, each operates as one of the network devices from the preceding figures.

Returning to FIG. 11, the example general purpose network device 1104 includes hardware 1140 comprising a set of one or more processor(s) 1142 (which are often COTS processors) and interface 1146, as well as memory 1148 having stored therein software 1150. During operation, the processor(s) 1142 execute the software 1150 to instantiate one or more sets of one or more applications 1164A-R. While certain embodiments do not implement virtualization, alternative embodiments may use different forms of virtualization. For example, in certain alternative embodiments virtualization layer 1154 represents the kernel of an operating system (or a shim executing on a base operating system) that allows for the creation of multiple instances 1162A-R called software containers that may each be used to execute one (or more) of the sets of applications 1164A-R. In this embodiment, software containers 1162A-R (also called virtualization engines, virtual private servers, or jails) are user spaces (typically a virtual memory space) that may be separate from each other and separate from the kernel space in which the operating system is run. In certain embodiments, the set of applications running in a given user space, unless explicitly allowed, may be prevented from accessing the memory of the other processes. In other such alternative embodiments virtualization layer 1154 may represent a hypervisor (sometimes referred to as a virtual machine monitor (VMM)) or a hypervisor executing on top of a host operating system; and each of the sets of applications 1164A-R may run on top of a guest operating system within an instance 1162A-R called a virtual machine (which in some cases may be considered a tightly isolated form of software container that is run by the hypervisor). In certain embodiments, one, some or all of the applications are implemented as unikernel(s), which can be generated by compiling directly with an application only a limited set of libraries (e.g., from a library operating system (LibOS) including drivers/libraries of OS services) that provide the particular OS services needed by the application. As a unikernel can be implemented to run directly on hardware 1140, directly on a hypervisor (in which case the unikernel is sometimes described as running within a LibOS virtual machine), or in a software container, embodiments can be implemented fully with unikernels running directly on a hypervisor represented by virtualization layer 1154, unikernels running within software containers represented by instances 1162A-R, or as a combination of unikernels and the above-described techniques (e.g., unikernels and virtual machines both run directly on a hypervisor, unikernels and sets of applications that are run in different software containers).

The instantiation of the one or more sets of one or more applications 1164A-R, as well as virtualization if implemented are collectively referred to as software instance(s) 1152. Each set of applications 1164A-R, corresponding virtualization construct (e.g., instance 1162A-R) if implemented, and that part of the hardware 1140 that executes them (be it hardware dedicated to that execution and/or time slices of hardware temporally shared by software containers 1162A-R), forms a separate virtual network element(s) 1160A-R.

The virtual network element(s) 1160A-R perform similar functionality to the virtual network element(s) 1130A-R. This virtualization of the hardware 1140 is sometimes referred to as network function virtualization (NFV)). Thus, NFV may be used to consolidate many network equipment types onto industry standard high volume server hardware, physical switches, and physical storage, which could be located in for example data centers and customer premise equipment (CPE). However, different embodiments of the invention may implement one or more of the software container(s) 1162A-R differently. While embodiments of the invention are illustrated with each instance 1162A-R corresponding to one VNE 1160A-R, alternative embodiments may implement this correspondence at a finer level granularity; it should be understood that the techniques described herein with reference to a correspondence of instances 1162A-R to VNEs also apply to embodiments where such a finer level of granularity and/or unikernels are used.

The third example ND implementation in FIG. 11 is a hybrid network device 1106, which includes both custom ASICs/proprietary OS and COTS processors/standard OS in a single ND or a single card within an ND. In certain embodiments of such a hybrid network device, a platform virtual machine (VM), such as a VM that that implements the functionality of the special-purpose network device 1102, could provide for para-virtualization to the hardware present in the hybrid network device 1106.

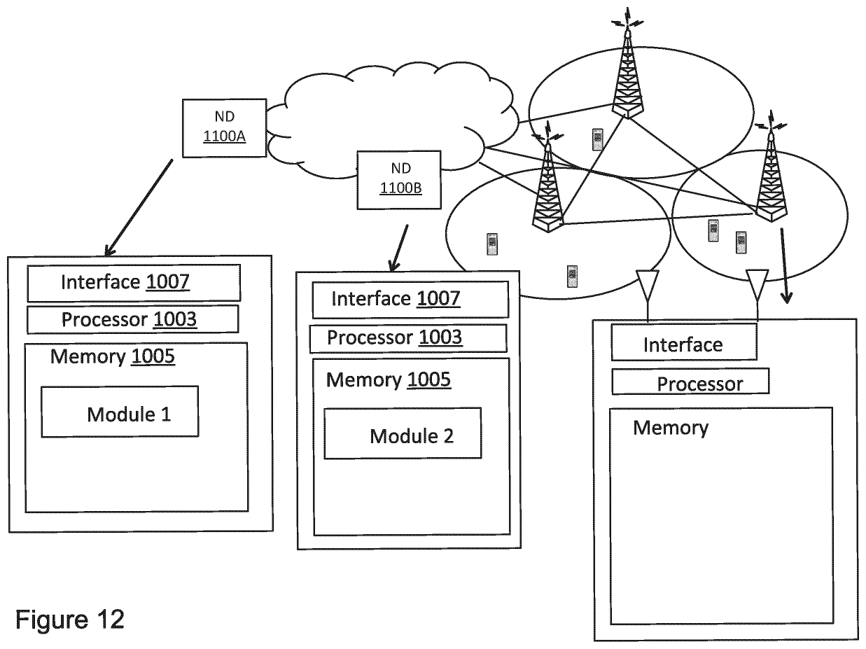

For reasons of simplicity and space many of the functions of the network device previously described with reference to FIG. 11 have been left out from FIG. 12.

Although the devices described herein may include the illustrated combination of hardware components, other embodiments may comprise computing devices with different combinations of components. It is to be understood that these devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the device, and/or performing one or more operations based on the obtained information or converted information, and as a result of said processing making a determination. Moreover, while components are depicted as single boxes located within a larger box, or nested within multiple boxes, in practice, devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by a wireless network generally.

Further definitions and embodiments are discussed below.

In the above-description of various embodiments of present inventive concepts, it is to be understood that the terminology used herein is for the purpose of describing particular embodiments only and is not intended to be limiting of present inventive concepts. Unless otherwise defined, all terms (including technical and scientific terms) used herein have the same meaning as commonly understood by one of ordinary skill in the art to which present inventive concepts belong. It will be further understood that terms, such as those defined in commonly used dictionaries, should be interpreted as having a meaning that is consistent with their meaning in the context of this specification and the relevant art and will not be interpreted in an idealized or overly formal sense unless expressly so defined herein.

When an element is referred to as being “connected”, “coupled”, “responsive”, or variants thereof to another element, it can be directly connected, coupled, or responsive to the other element or intervening elements may be present. In contrast, when an element is referred to as being “directly connected”, “directly coupled”, “directly responsive”, or variants thereof to another element, there are no intervening elements present. Like numbers refer to like elements throughout. Furthermore, “coupled”, “connected”, “responsive”, or variants thereof as used herein may include wirelessly coupled, connected, or responsive. As used herein, the singular forms “a”, “an” and “the” are intended to include the plural forms as well, unless the context clearly indicates otherwise. Well-known functions or constructions may not be described in detail for brevity and/or clarity. The term “and/or” (abbreviated “/”) includes any and all combinations of one or more of the associated listed items.

It will be understood that although the terms first, second, third, etc. may be used herein to describe various elements/operations, these elements/operations should not be limited by these terms. These terms are only used to distinguish one element/operation from another element/operation. Thus a first element/operation in some embodiments could be termed a second element/operation in other embodiments without departing from the teachings of present inventive concepts. The same reference numerals or the same reference designators denote the same or similar elements throughout the specification.

As used herein, the terms “comprise”, “comprising”, “comprises”, “include”, “including”, “includes”, “have”, “has”, “having”, or variants thereof are open-ended, and include one or more stated features, integers, elements, steps, components or functions but does not preclude the presence or addition of one or more other features, integers, elements, steps, components, functions or groups thereof. Furthermore, as used herein, the common abbreviation “e.g.”, which derives from the Latin phrase “exempli gratia,” may be used to introduce or specify a general example or examples of a previously mentioned item, and is not intended to be limiting of such item. The common abbreviation “i.e.”, which derives from the Latin phrase “id est,” may be used to specify a particular item from a more general recitation.

Example embodiments are described herein with reference to block diagrams and/or flowchart illustrations of computer-implemented methods, apparatus (systems and/or devices) and/or computer program products. It is understood that a block of the block diagrams and/or flowchart illustrations, and combinations of blocks in the block diagrams and/or flowchart illustrations, can be implemented by computer program instructions that are performed by one or more computer circuits. These computer program instructions may be provided to a processor circuit of a general purpose computer circuit, special purpose computer circuit, and/or other programmable data processing circuit to produce a machine, such that the instructions, which execute via the processor of the computer and/or other programmable data processing apparatus, transform and control transistors, values stored in memory locations, and other hardware components within such circuitry to implement the functions/acts specified in the block diagrams and/or flowchart block or blocks, and thereby create means (functionality) and/or structure for implementing the functions/acts specified in the block diagrams and/or flowchart block(s).

These computer program instructions may also be stored in a tangible computer-readable medium that can direct a computer or other programmable data processing apparatus to function in a particular manner, such that the instructions stored in the computer-readable medium produce an article of manufacture including instructions which implement the functions/acts specified in the block diagrams and/or flowchart block or blocks. Accordingly, embodiments of present inventive concepts may be embodied in hardware and/or in software (including firmware, resident software, micro-code, etc.) that runs on a processor such as a digital signal processor, which may collectively be referred to as “circuitry,” “a module” or variants thereof.

It should also be noted that in some alternate implementations, the functions/acts noted in the blocks may occur out of the order noted in the flowcharts. For example, two blocks shown in succession may in fact be executed substantially concurrently or the blocks may sometimes be executed in the reverse order, depending upon the functionality/acts involved. Moreover, the functionality of a given block of the flowcharts and/or block diagrams may be separated into multiple blocks and/or the functionality of two or more blocks of the flowcharts and/or block diagrams may be at least partially integrated. Finally, other blocks may be added/inserted between the blocks that are illustrated, and/or blocks/operations may be omitted without departing from the scope of inventive concepts. Moreover, although some of the diagrams include arrows on communication paths to show a primary direction of communication, it is to be understood that communication may occur in the opposite direction to the depicted arrows.

Many variations and modifications can be made to the embodiments without substantially departing from the principles of the present inventive concepts. All such variations and modifications are intended to be included herein within the scope of present inventive concepts. Accordingly, the above disclosed subject matter is to be considered illustrative, and not restrictive, and the examples of embodiments are intended to cover all such modifications, enhancements, and other embodiments, which fall within the spirit and scope of present inventive concepts. Thus, to the maximum extent allowed by law, the scope of present inventive concepts are to be determined by the broadest permissible interpretation of the present disclosure including the examples of embodiments and their equivalents, and shall not be restricted or limited by the foregoing detailed description.

1. A computer-implemented method performed by a computing device for verification of a site deployment, the method comprising:
receiving a query that a property related to an object from a three-dimensional, 3-D, representation from a scan of the site deployment satisfies a specified property related to the object from a drawing of the design of the site;
initiating extraction of a first value for the specified property related to the object from a first knowledge graph based on the drawing and a second value for the property related to the object from a second knowledge graph based on the 3-D representation from the scan;
determining whether the property related to the object from the 3-D representation satisfies the specified property related to the object from the drawing based on a comparison of the first and second values; and
outputting a result of the determining that indicates whether the property related to the object from the 3-D representation satisfies the specified property related to the object from the drawing.

2. The method of claim 1, wherein the drawing comprises a depiction of a plurality of objects, a relationship between at least the object and another object, and a text label that describes at least the specified property of the object.

3. The method of claim 1, wherein the 3-D representation from the scan comprises at least one of a point cloud scan, a 3-D mesh, and a 3-D voxel comprising a representation of a plurality of objects in the site deployment, and a relationship between at least the object and another object.

4. The method of claim 1, wherein the query comprises a natural language query.

5. The method of claim 1, further comprising:
extracting information from the query comprising the object and the property related to the object; and
using the extracted information to make a (i) query on the first knowledge graph for the object and the specified property related to the object to obtain the first value, and (ii) query on the second knowledge graph for the object and the property related to the object to obtain the second value.

6. The method of claim 1, wherein the extracting comprises generating the first knowledge graph based on the drawing of the design of the site; and generating the second knowledge graph based on the 3-D representation of the site deployment.

7. The method of claim 6, wherein the generating the first knowledge graph comprises extracting, from the drawing, a symbolic representation in the form of a plurality of nodes and a plurality of edges of the first knowledge graph.

8. The method of claim 7, wherein respective nodes from the plurality of nodes correspond to at least one of (i) a localization and categorization of the object from the drawing, or (ii) a measurement value for the object, and respective edges from the plurality of edges encode a pairwise relationship between at least the object and another object from the drawing.

9. The method of claim 7, wherein the extracting the symbolic representation comprises one or more of (i) detecting the object from the drawing; (ii) detecting, from the drawing, the specified property related to the object, (iii) recognizing a text description, from the drawing, related to the object, and (iv) detecting a relationship or connection between the object and another object when available.

10. The method of claim 6, wherein the generating the first knowledge graph further comprises augmenting the first knowledge graph with information about the object obtained from an external third knowledge graph comprising information about at least the object or a knowledge graph of general information.

11. The method of claim 6, wherein the generating the second knowledge graph comprises extracting, from the 3-D representation, a symbolic representation in the form of a plurality of nodes and a plurality of edges of the second knowledge graph.

12. The method of claim 11, wherein respective nodes from the plurality of nodes correspond to a plurality of objects and a measurement value for the object, and the respective edges from the plurality of edges encode a pairwise relationship between at least the object and another object from the 3-D representation.

13. The method of anyone of claim 11, wherein the extracting the symbolic representation comprises one or more of (i) detecting the object from the 3-D representation; (ii) detecting, from the 3-D representation, the property related to the object; and (iii) extracting a relationship or a connection between the object and another object when available.

14. The method of claim 1, further comprising:
extending the second knowledge graph to include a link to a node for the object in the first knowledge graph.

15. The method of claim 1, further comprising:
extending the second knowledge graph to align a node for the object in the first knowledge graph to a node in the second knowledge graph based on a score having a highest value for a match between the node for the object in the first knowledge graph and the node in the second knowledge graph.

16. The method of claim 1, further comprising:
augmenting the second knowledge graph with at least one relative measurement between the object and another object, the relative measurement comprising at least a relative distance.

17. The method of claim 1, wherein the result comprises at least one of one of (i) a pass indication or a fail indication, (ii) whether a difference between the first value and the second value is within a threshold value; and (ii) whether the second value is with a specified percentage of the first value.

18. The method of claim 1, wherein the drawing comprises a drawing of a design of at least a portion of radio site and the 3-D representation from the scan comprises at least the portion of the site deployed based on the drawing.

19. A computing device configured for verification of a site deployment, the computing device comprising:
processing circuitry;
memory coupled with the processing circuitry, wherein the memory includes instructions that when executed by the processing circuitry causes the computing device to perform operations comprising:
receive a query that a property related to an object from a three-dimensional, 3-D, representation from a scan of the site deployment satisfies a specified property related to the object from a drawing of the design of the site;
initiate extraction of a first value for the specified property related to the object from a first knowledge graph based on the drawing and a second value for the property related to the object from a second knowledge graph based on the 3-D representation from the scan;
determine whether the property related to the object from the 3-D representation satisfies the specified property related to the object from the drawing based on a comparison of the first and second values; and
output a result of the determining that indicates whether the property related to the object from the 3-D representation satisfies the specified property related to the object from the drawing.

20.-24. (canceled)

25. A computer program product comprising a non-transitory storage medium including program code to be executed by processing circuitry of a computing device configured for verification of a site deployment, whereby execution of the program code causes the computing device to perform operations comprising:
receive a query that a property related to an object from a three-dimensional, 3-D, representation from a scan of the site deployment satisfies a specified property related to the object from a drawing of the design of the site;
initiate extraction of a first value for the specified property related to the object from a first knowledge graph based on the drawing and a second value for the property related to the object from a second knowledge graph based on the 3-D representation from the scan;
determine whether the property related to the object from the 3-D representation satisfies the specified property related to the object from the drawing based on a comparison of the first and second values; and
output a result of the determining that indicates whether the property related to the object from the 3-D representation satisfies the specified property related to the object from the drawing.

26. (canceled)
